(19) United States
(12) Patent Application Publication
(10) Pub. No.: US 2025/0061591 A1
(43) Pub. Date: Feb. 20, 2025

(54) STACKING COLOR AND MOTION SIGNAL TO DETECT TINY OBJECTS

(71) Applicant: Epirus, Inc., Torrance, CA (US)

(72) Inventors: Rahul Pramod Krupani, Los Angeles, CA (US); Jiejie Zhu, Mercer Island, CA (US); Aleksandar Kojic, Seattle, WA (US)

(21) Appl. No.: 18/801,300

(22) Filed: Aug. 12, 2024

Related U.S. Application Data
(60) Provisional application No. 63/532,649, filed on Aug. 14, 2023.

(51) Int. Cl. G06T 7/246; G06V 10/77; G06V 10/774; G06V 10/82; G06V 20/50

(52) U.S. Cl. CPC G06T 7/248; G06V 10/7715; G06V 10/774; G06V 10/82; G06T 2200/24; G06T 2207/10024; G06T 2207/10028; G06T 2207/10048; G06T 2207/20021; G06T 2207/20081; G06T 2207/20084; G06T 2207/20092; G06V 20/50; G06V 2201/08

(57) ABSTRACT

A system can include an image capture system configured to obtain image data comprising at least a first image frame and a second image frame and a memory storing instructions that, when executed by one or more processors, cause the one or more processors to process a first set of image data based on the first image frame, process a second set of image data based on the first image frame and the second image frame, and execute a network model configured to detect one or more targeted objects from a plurality of potential objects in the first image frame based on an input comprising the first set of image data and the second set of image data, the one or more targeted objects comprising less than 1/100th pixels of a total number of pixels in the first image frame.

### CROSS-REFERENCE TO RELATED APPLICATIONS

This application claims priority to U.S. Provisional Application No. 63/532,649, filed Aug. 14, 2023, which is hereby incorporated by reference in its entirety for all purposes. Any and all applications for which a foreign or domestic priority claim is identified in the Application Data Sheet as filed with the present application are hereby incorporated by reference under 37 CFR 1.57.

### TECHNICAL FIELD

The present disclosure relates, in general, to systems and methods for detecting and tracking objects, and more particularly, to techniques for tracking objects in real time images. The present disclosure also relates, in general, to motion detection and, more particularly, to real-time motion detection of tiny objects in video data.

### BACKGROUND

The proliferation of unmanned aerial vehicles (UAVs) presents a threat to persons, property, and national security. Detecting objects using computer vision has been implemented in applications like surveillance, healthcare, autonomous driving, and other image or video-based tasks. However, accurate detection of UA Vs using computer vision can be difficult when captured at a distance due to the low number of pixels representing a UAV relative to the overall image size. Motion blur, occlusion, changes in shape, and digital noise may reduce accurate detection of UAVs captured at a distance. Utilizing motion data can be an ineffective solution given the size of the objects, and dense flow calculations are too complex to be implemented in real-time. Achieving a balance between computational accuracy and robust detection across diverse conditions and object variations remains an active area of research.

### SUMMARY

The disclosure generally contemplates systems and methods for detecting objects represented by a small number of pixels in an image or images using Artificial Intelligence (AI).

In some aspects, the techniques described herein relate to an object detection system, including: an image capture system configured to obtain image data including at least a first image frame and a second image frame; and a memory storing instructions that, when executed by one or more processors, cause the one or more processors to: process a first set of image data based on the first image frame, process a second set of image data based on the first image frame and the second image frame, and execute a network model configured to detect one or more targeted objects from a plurality of potential objects in the first image frame based on an input including the first set of image data and the second set of image data, the one or more targeted objects including less than 1/100th pixels of a total number of pixels in the first image frame.

In some aspects, the techniques described herein relate to an object detection system, wherein the first set of image data includes color data and the second set of image data includes motion data.

In some aspects, the techniques described herein relate to an object detection system, wherein the color data includes red, green, and blue (RGB) data and the motion data includes differential data.

In some aspects, the techniques described herein relate to an object detection system, wherein the color data includes at least more than one types of data in the first image frame.

In some aspects, the techniques described herein relate to an object detection system, wherein the execution of the instructions causes the one or more processors to determine the motion data based on the first image frame and the second image frame.

In some aspects, the techniques described herein relate to an object detection system, wherein the motion data is determined based on optical flow.

In some aspects, the techniques described herein relate to an object detection system, wherein execution of the instructions causes the one or more processors to determine the motion data based on a difference between the first image frame and the second image frame.

In some aspects, the techniques described herein relate to an object detection system, wherein the motion data is determined according to: D(x, y)=|It(x, y)−It+1(x, y)|, wherein It(x, y) includes a value at each pixel in the first image frame and It+1(x, y) includes a value for each pixel in the second image frame.

In some aspects, the techniques described herein relate to an object detection system, wherein execution of the instructions causes the one or more processors to convert to greyscale the first image frame and the second image frame and determine the motion data from greyscale first image frame and the greyscale second image frame.

In some aspects, the techniques described herein relate to an object detection system, wherein determination of the motion data includes comparing difference between the first image frame and the second image frame with a differential threshold value.

In some aspects, the techniques described herein relate to an object detection system, wherein the color data includes at least one threshold value determined based on a comparison of at least one value for each pixel of the first image frame and a threshold value.

In some aspects, the techniques described herein relate to an object detection system, wherein the first image frame includes at least three values for each type of data in each pixel and the at least one threshold value is determined based on a comparison of the at least three values of the first image frame and a threshold value for each of the corresponding types of data.

In some aspects, the techniques described herein relate to an object detection system, wherein the first set of image data and the second set of image data are both red, green, and blue (RGB) data.

In some aspects, the techniques described herein relate to an object detection system, wherein execution of the instructions causes the one or more processors to process a third set of image data based on the first image frame and a third image frame, and input the third set of image data into the network model.

In some aspects, the techniques described herein relate to an object detection system, wherein execution of the instructions causes the one or more processors to output a first detection of the one or more targeted objects based on an input of the first set of image data and the second set of image data, and output a second detection of the one or more targeted objects based on an input of the first set of image data and the third set of image data.

In some aspects, the techniques described herein relate to an object detection system, wherein the first image frame and the second image frame are sequential.

In some aspects, the techniques described herein relate to an object detection system, wherein the first image and the second image frame are sequentially separated by at least one other image frame.

In some aspects, the techniques described herein relate to an object detection system, wherein the one or more targeted objects including less than 1/500th pixels of a total number of pixels in the first image frame.

In some aspects, the techniques described herein relate to an object detection system, wherein the one or more targeted objects including less than 1/500000th pixels of a total number of pixels in the first image frame.

In some aspects, the techniques described herein relate to an object detection system, wherein the network model is configured to generate at least one Gaussian Receptive Fields (GRFs) to dynamically adapt to features of the one or more targeted objects in at least one of the first image frame or the second image frame.

In some aspects, the techniques described herein relate to an object detection system, wherein execution of the instructions causes the one or more processors to divide the first image frame into a plurality of image tiles.

In some aspects, the techniques described herein relate to an object detection system, wherein the network model is configured to apply one or more of the GRFs to each of the plurality of image tiles independently to capture spatial features and temporal features associated with the one or more targeted objects in the first image frame.

In some aspects, the techniques described herein relate to an object detection system, wherein the network model is configured to apply one or more of the GRFs to the first image frame to capture spatial features and temporal features associated with the one or more targeted objects in the first image frame.

In some aspects, the techniques described herein relate to an object detection system, wherein execution of the instructions causes the one or more processors to detect the one or more targeted objects in each of the plurality of image tiles, the one or more targeted objects including less than a factor of each of the image tiles, the factor being 1/100th multiplied by a number of image tiles of the plurality of tiles, and wherein execution of the instructions cause the one or more processors to aggregate the plurality of images tiles for the detection of the one or more targeted objects in the first image frame.

In some aspects, the techniques described herein relate to an object detection system, wherein execution of the instruction causes the one or more processors to alert a user responsive to the one or more targeted objects being detected in an image tile of the plurality of image tiles.

In some aspects, the techniques described herein relate to an object detection system, wherein execution of the instructions causes the one or more processors to identify the one or more targeted objects based on a maximum likelihood estimation.

In some aspects, the techniques described herein relate to an object detection system, wherein the network model includes a neural network model configured to process a stacked data set of the first image frame to detect the one or more targeted objects in the first image frame, the stacked data set including the first set of image data and the second set of image data.

In some aspects, the techniques described herein relate to an object detection system, wherein the network model includes a modified You Only Look Once (YOLO) architecture.

In some aspects, the techniques described herein relate to an object detection system, wherein the modified YOLO architecture includes a feature pyramid network configured to upsample the image data by at least four times to capture fine-grained details of the one or more targeted objects in the first image frame.

In some aspects, the techniques described herein relate to an object detection system, wherein the modified YOLO architecture is configured to perform compound scaling of the image data.

In some aspects, the techniques described herein relate to an object detection system, wherein the network model includes a Convolutional Neural Network (CNN) model trained on synthetic image data and factual image data for tiny targeted object detection, identification, and tracking.

In some aspects, the techniques described herein relate to an object detection system, wherein execution of the instructions causes the one or more processors to determine a confidence score for the one or more targeted objects.

In some aspects, the techniques described herein relate to an object detection system, further including a display configured to display the first image frame, the one or more targeted objects, and features corresponding to each of the one or more targeted objects, wherein execution of the instructions causes the one or more processors to determine the features including a bounding box surrounding the one or more targeted objects and the confidence score for the one or more targeted objects.

In some aspects, the techniques described herein relate to an object detection system, wherein the features further include at least one of an expected velocity of the one or more targeted objects, a predicted position of the one or more targeted objects, or a direction of travel of the one or more targeted objects.

In some aspects, the techniques described herein relate to an object detection system, wherein the one or more targeted objects change at least one of an appearance or a location from the first image frame in the first image frame to the second image frame, and wherein the display is configured to display the first image frame, the one or more targeted objects in each respective image frame of the image data, and at least one of the features corresponding to each of the one or more targeted objects in a sequential order from the first image frame to the second image frame.

In some aspects, the techniques described herein relate to an object detection system, wherein the one or more processors are further caused to detect the one or more targeted objects and the corresponding features in 500 milliseconds or less.

In some aspects, the techniques described herein relate to an object detection system, wherein the one or more processors are further caused to detect the one or more targeted objects and the corresponding features in 100 milliseconds or less.

In some aspects, the techniques described herein relate to an object detection system, wherein execution of the instructions causes the one or more processors to track the one or more targeted objects from the first image frame to the second image frame.

In some aspects, the techniques described herein relate to an object detection system, wherein the plurality of potential objects includes animals, unmanned vehicles, and manned vehicles, and wherein the one or more targeted objects include the unmanned vehicles.

In some aspects, the techniques described herein relate to an object detection system, wherein the image capture system includes a multi-modality image capture system.

In some aspects, the techniques described herein relate to an object detection system, wherein the image capture system includes one or more cameras configured for thermal detection.

In some aspects, the techniques described herein relate to an object detection system, wherein the image capture system includes one or more radars.

In some aspects, the techniques described herein relate to an object detection system, wherein the image capture system includes one or more cameras configured to be synchronized together to capture images at a constant rate.

In some aspects, the techniques described herein relate to an object detection system, wherein the network model is configured to determine at least one loss function associated with the detection of the one or more targeted objects.

In some aspects, the techniques described herein relate to an object detection system, wherein execution of the instructions causes the one or more processors to determine a confidence score for the detection of the one or more targeted objects, the confidence score being associated with at least one of the at least one loss function or an image quality associated with the image data.

In some aspects, the techniques described herein relate to an object detection system, wherein execution of the instructions causes the one or processors to train the network model based on the at least one loss function.

In some aspects, the techniques described herein relate to an object detection system, wherein execution of the instructions causes the one or more processors to train the network model based on training data including the plurality of potential objects in various scenarios.

In some aspects, the techniques described herein relate to an object detection system, wherein the various scenarios include at least one of the plurality of potential objects in at least one of a different orientation or distance.

In some aspects, the techniques described herein relate to an object detection system, wherein execution of the instructions causes the one or more processors to: detect that the one or more targeted objects is carrying a payload, and alert a user on a location of the one or more targeted objects carrying the payload.

In some aspects, the techniques described herein relate to an object detection system, further including: a neutralization system configured to neutralize the one or more targeted objects carrying the payload.

In some aspects, the techniques described herein relate to a method of operating the object detection system of any of the preceding paragraphs and/or any of the disclosed object detection systems.

In some aspects, the techniques described herein relate to a method for detecting an object in an image frame, the method including, by one or more processors: receiving real-time image data including a first image frame and a second image frame; processing a first set of image data based on the first image frame; processing a second set of image data based on the first image frame and the second image frame; inputting the first set of image data and the second set of image data into a network model; and with the network model, detecting one or more targeted objects from a plurality of potential objects in the first image frame, the one or more targeted objects including less than 1/100th pixels of a total number of pixels in the first image frame.

In some aspects, the techniques described herein relate to a method, wherein the real-time image data is received at a first time, and the one or more targeted objects in the first image frame are detected at a second time, the second time being 500 milliseconds or less after the first time.

In some aspects, the techniques described herein relate to a method for training an object detection system, the method including, by one or more processors: inputting training data including a plurality of potential objects in various scenarios into a network model, the plurality of potential objects including one or more targeted objects; training the network model based on the training data to detect the one or more targeted objects from among the plurality of potential objects; processing a first set of image data based on a first image frame and a second set of image data based on the first image frame and a second image frame; inputting the first set of image data and the second set of image data into the network model, the network model configured to detect the one or more targeted objects in the first image frame, the one or more potential objects including less than 1/100th pixels of a total number of pixels in the image frame; processing at least a portion of the first image frame including at least one of the one or more targeted objects with the network model to detect the one or more targeted objects; inputting, via a user interface, a ground truth for any of the one or more targeted objects not detected by the network model; determining at least one loss function associated with each of the one or more targeted objects detected; and re-training the network model based on the at least one loss function.

In some aspects, the techniques described herein relate to a method, wherein the at least one loss function includes at least one of class loss, box loss, or objectness loss.

In some aspects, the techniques described herein relate to a method, further including, by the one or more processors, determining a confidence score for the detection of the one or more targeted objects, the confidence score being associated with at least one of the at least one loss function or an image quality associated with the image data.

In some aspects, the techniques described herein relate to a method, wherein the training data includes a plurality of object images, each of the plurality of object images including a representation of one of the plurality of potential objects in a particular scenario of the various scenarios.

In some aspects, the techniques described herein relate to a method, wherein the particular scenario includes at least one of a particular orientation, a particular lighting, or a particular distance, a first object image of the plurality of images includes a particular object of the plurality of potential objects in a first particular scenario, a second object image of the plurality of images includes the same particular object in a second particular scenario, and wherein the first particular scenario is different from the second particular scenario.

In some aspects, the techniques described herein relate to a method, wherein the plurality of potential objects further includes a type of object, the type of object including the one or more targeted objects and at least one non-targeted object, and each of the plurality of object images includes a label associated with the object represented in corresponding object image, the label including the type of object and the particular scenario of the object, and wherein the network model is trained by processing each of the objects and the corresponding label in each of the plurality of object images.

In some aspects, the techniques described herein relate to a method, wherein the first set of image data includes color data and the second set of image data includes motion data.

In some aspects, the techniques described herein relate to a method, wherein the color data includes red, green, and blue (RGB) data and the motion data includes differential data.

In some aspects, the techniques described herein relate to a method, wherein the color data includes at least more than one type of data in each pixel of the first image frame.

In some aspects, the techniques described herein relate to a method, further including, by the one or more processors, determining the motion data based on the first image frame and the second image frame.

In some aspects, the techniques described herein relate to a method, wherein the motion data is determined based on optical flow.

In some aspects, the techniques described herein relate to a method, wherein the motion data includes a difference between the first image frame and the second image frame.

In some aspects, the techniques described herein relate to a method, wherein the motion data is determined according to: D(x, y)=|It(x, y)−It+1(x, y)|, wherein It(x, y) includes a value at each pixel in the first image frame and It+1(x, y) includes a value for each pixel in the second image frame.

In some aspects, the techniques described herein relate to a method, further including, by the one or more processors, converting to greyscale the first image frame and the second image frame and determining the motion data from greyscale first image frame and greyscale second image frame.

In some aspects, the techniques described herein relate to a method, wherein determining the motion data further includes comparing a difference between the first image frame and the second image frame with a differential threshold value.

In some aspects, the techniques described herein relate to a method, wherein the color data includes at least one thresholded value determined based on a comparison of at least one value for each pixel of the first image frame and a threshold value.

In some aspects, the techniques described herein relate to a method, wherein the first image frame includes at least three values for each type of data in each pixel and the at least one thresholded value is determined based on a comparison of the at least three values of the first image frame and a threshold value for each of the corresponding types of data.

In some aspects, the techniques described herein relate to a method, wherein the first set of image data and the second set of image data are red, green, and blue (RGB) data.

In some aspects, the techniques described herein relate to a method, further including, by the one or more processors, processing a third set of image data based on the first image frame and a third image frame, and inputting the third set of image data into the network model.

In some aspects, the techniques described herein relate to a method, further including, by the network model, outputting a first detection of the one or more targeted objects based on an input of the first set of image data and the second set of image data, outputting a second detection of the one or more targeted objects based on an input of the first set of image data and the third set of image data, and comparing an accuracy and a recall of the first detection and the second detection.

In some aspects, the techniques described herein relate to a method, wherein the first image frame and the second image frame are sequential.

In some aspects, the techniques described herein relate to a method, wherein the first image and the second image frame are sequentially separated by at least one other image frame.

In some aspects, the techniques described herein relate to a method, wherein the one or more targeted objects including less than 1/500th pixels of a total number of pixels in the first image frame.

In some aspects, the techniques described herein relate to a method, wherein the one or more targeted objects including less than 1/500000th pixels of a total number of pixels in the first image frame.

In some aspects, the techniques described herein relate to a method, further including, by the network model, generating at least one Gaussian Receptive Fields (GRFs) to dynamically adapt to features of the one or more targeted objects in at least one of the first image frame or the second image frame.

In some aspects, the techniques described herein relate to a method, further including, by the one or more processors, dividing the first image frame into a plurality of image tiles.

In some aspects, the techniques described herein relate to a method, further including, by the network model, applying one or more of the GRFs to each of the plurality of image tiles independently to capture spatial features and temporal features in the one or more targeted objects in the first image frame.

In some aspects, the techniques described herein relate to a method, further including, by the network model, applying one or more of the GRFs to the first image frame to capture spatial features and temporal features in the one or more targeted objects in the first image frame.

In some aspects, the techniques described herein relate to a method, further including, by the one or more processors, detecting the one or more targeted objects in each of the plurality of image tiles, the one or more targeted objects including less than a factor of each of the image tiles, the factor being 1/100th multiplied by a number of image tiles of the plurality of tiles, and aggregating the plurality of images tiles for the detection of the one or more targeted objects in the first image frame.

In some aspects, the techniques described herein relate to a method, further including, by the one or more processors, identifying the one or more targeted objects based on a maximum likelihood estimation.

In some aspects, the techniques described herein relate to a method, wherein the network model includes a neural network model, the method further including, by the neural network model, processing a stacked data set of the first image frame to detect the one or more targeted objects in the first image frame, the stacked data set including the first set of image data and the second set of image data.

In some aspects, the techniques described herein relate to a method, wherein the network model includes a modified You Only Look Once (YOLO) architecture.

In some aspects, the techniques described herein relate to a method, wherein the modified YOLO architecture includes a feature pyramid network, the method further including, by the feature pyramid network, upsampling the image data by at least four times to capture fine-grained details of the one or more targeted objects in the first image frame.

In some aspects, the techniques described herein relate to a method, further including, by the modified YOLO architecture, performing compound scaling of the image data.

In some aspects, the techniques described herein relate to a method, wherein the network model includes a Convolutional Neural Network (CNN) model trained on a diverse synthetic and factual image data for tiny targeted object detection, identification, and tracking.

In some aspects, the techniques described herein relate to a method, further including, by the one or more processors, determining a confidence score for the one or more targeted objects.

In some aspects, the techniques described herein relate to a method, further including: by a display, displaying the first image frame, the one or more targeted objects, and features corresponding to each of the one or more targeted objects, wherein determining the features includes generating a bounding box surrounding the one or more targeted objects and the confidence score for the one or more targeted objects.

In some aspects, the techniques described herein relate to a method, wherein the features further include at least one of an expected velocity of the targeted object, a predicted position of the targeted object, or a direction of travel of the targeted object.

In some aspects, the techniques described herein relate to a method, wherein the one or more targeted objects change at least one of an appearance or location from a first image frame in the first image frame to the second image frame, and the method further including, by a display, displaying the first image frame, the one or more targeted objects in each respective image frame of the image data, and at least one of the features corresponding to each of the one or more targeted objects in a sequential order from the first image frame to the second image frame.

In some aspects, the techniques described herein relate to a method, further including, by the one or more processors, detecting the one or more targeted objects and the corresponding features in 500 milliseconds or less.

In some aspects, the techniques described herein relate to a method, further including, by the one or more processors, detecting the one or more targeted objects and the corresponding features in 100 milliseconds or less.

In some aspects, the techniques described herein relate to a method, further including, by the one or more processors, tracking the one or more targeted objects from the first image frame to the second image frame.

In some aspects, the techniques described herein relate to a method, wherein the plurality of potential objects includes animals, unmanned vehicles, and manned vehicles, and wherein the one or more targeted objects include the unmanned vehicles.

The systems, methods, techniques, modules, and devices of this disclosure each have several innovative aspects, no single one of which is solely responsible for the desirable attributes disclosed herein.

### BRIEF DESCRIPTION OF THE FIGURES

The disclosure is more fully appreciated in connection with the following detailed description taken in conjunction with the accompanying drawings, in which:

FIG. 1 shows an environment in which an image processing system detects target objects in video data.

FIG. 2 shows how the image processing system uses the plurality of images as both video data and differential image data.

FIG. 3 shows a training process of a Neural Network (NN) model of an image processing system.

FIG. 4A shows an example set of results demonstrating the efficacy of the image processing system implementing the NN model.

FIG. 4B shows an example set of results demonstrating the efficacy of the image processing system implementing the NN model.

FIG. 4C shows a set of results demonstrating the efficacy of the image processing system implementing the NN model.

FIGS. 5A and 5B illustrate the flow chart of image processing.

FIGS. 6A and 6B illustrate an output of image detecting system.

FIG. 7 illustrates a method for performing target object detection and tracking.

Like reference numerals refer to corresponding parts throughout the several views of the drawings.

### DETAILED DESCRIPTION

The present disclosure provides examples of apparatuses, systems, and methods for detecting motion of objects represented by a small number of pixels within image data in real time, such as using a real time image or video frame, and in a real-world environment. In some instances, the detection of an object can occur in less than 100 milliseconds of capturing an image of the object, so that ten frame assessments can be completed per second. Thus, the detection and tracking of the targeted object and its motion can be completed, for example, in less than 300 milliseconds. The amount of time can be less depending on the size of the image and the values referred to are intended to be exemplary. For instance, in some images, an image frame can be processed and detection can be completed in less than 1 second, 900milliseconds, 800 milliseconds, 700 milliseconds, 650 milliseconds, 350 milliseconds, 200milliseconds, 100 milliseconds, 50 milliseconds, etc.

More particularly, at least some implementations of the present disclosure introduce features for detection of tiny objects (referred to as UAVs in the disclosure) and motion of the object within a field of view of one or more cameras, such as by implementing a network model, such as a Deep Learning Neural Network architecture, which is trained to detect the target objects based on high-resolution image data. In some instances, the network model may result in false positive detection of the target objects, which can be represented as bounding boxes around the false positive UAVs (e.g., manned aerial vehicles, animals, weather phenomenon, image capturing errors, etc.), and an additional Non-Maximum Suppression (NMS) can be implemented to suppress the least likely detected objects, such as the worse bounding boxes with the lowest confidence score. These tiny objects (or small objects) can be typically far away from the image-capturing device and therefore the number of pixels representing the object can be minuscule in comparison to the number of pixels representing the total image size (such as, but not limited to, being 1/50th, 1/100th, 1/150th, 1/200th, 1/300th, 1/500th, 1/750th, 1/1000th, 1/10000th, 1/100000th, 1/1000000th, etc., of the total image size). Even when being captured by a high-definition camera, such tiny objects may be represented by a number of pixels on the order of only 350 pixels, 250 pixels, 100 pixels, 90 pixels, 80 pixels, 65 pixels, 50 pixels, 35 pixels, 20 pixels, 15 pixels, 5 pixels, 1pixel, etc. in size. Additionally, the image captured can be by a high-definition image capturing system 106, such as an 8K camera, and can have a resolution of 8000×8000. This resolution is intended to merely be an example and can be any resolution, such as 3000×3000, 4000×4000, etc. These values are merely exemplary and are not intended to be limiting.

Waiting until the object is closer to the image capturing device so that it is no longer tiny would help increase the number of pixels representing the object; however, this may be inadvisable if the target object is a UAV carrying a payload (which may be dangerous) or a reconnaissance UAV, or another dangerous object. Accordingly, detecting the object when it is that close may reduce the ability to successfully implement defensive measures. As a result, the object may need to be captured for detection as far as possible, such as, but not limited to, within 4000, 2000 meters, 1500 meters, 1000 meters, 800 meters, 750 meters, 500 meters, 200 meters, etc., and concurrently captured to track its movement. The Deep Learning Neural Network (DNN), in some aspects, includes features of a Convolutional Neural Network (CNN) and may be configured to detect tiny (or small) objects at an extended distance through innovative design enhancements, such as adjusting an input to include both red, green, and blue (RGB) data and motion data. Small objects can be difficult to detect due to the low number of pixels with which they can be represented due to the distance they can be captured at. Furthermore, small objects can be difficult to identify as an object of interest, as the low number of pixels may appear similar to many other potential objects, such as flying animals and manned vehicles.

Utilizing a traditional object detection system that reviews each pixel in the image could more accurately identify the object as a targeted object or not from the potential objects, but it could also exponentially increase the processing requirements of a system, which can reduce the speed that frames can be analyzed and target objects identified to the user. In some cases, the speed can be reduced such that a UAV carrying a payload may be identified and notified to the user after it is too late to take preventative or defensive actions. Instead, at least some implementations of the present disclosure reduce the amount of processing time implemented in the traditional approach by leveraging the additional motion data to supplement the RGB data. Due to the low number of pixels that represent the UAV, it would typically be difficult to detect the UAV without a processing system evaluating each pixel to detect the UAV, particularly in fine-tuned systems that can reduce the number of false positives (such as, from birds) but further increase the processing requirements. Rather than that, at least some implementations supplement the limited RGB data with a fourth layer comprising motion data captured between at least two frames to accurately detect UAVs from a distance without the processing requirements of traditional techniques. In some instances, this motion data can indicate any changes between image frames to narrow down the amount of the image frame that needs to be analyzed. This is similar to how the human brain may have a difficult time spotting movement from a still image, but can more easily track and determine the location of an object if it captures movement. However, unlike the human brain and eye, which could not physically see even a moving UAV at large distances or be able to comprehend that there is movement, at least some implementations leverage an object detection system to capture distant objects and any associated movement, even if small. For example, with an 8000×8000 image frame including a UAV represented by 10 pixels, the change in movement may only be a 2 pixel shift from one image frame to the next, which to a human eye may appear as if there were no movement. In said example, a human eye would not be able to comprehend the movement of the small object even if there were a 10 pixel shift (the full size of the example UAV), 15 pixel shift, 20 pixel shift, 50 pixel shift, etc.

Moreover, at least some implementations of systems and methods provide tracking statistics or label assignments using Max Intersection of Union (IOU) or Adaptive Training Sample Selection (ATSS) process(es) for small objects with limited bounding box information. This can provide an approach that balances positive and negative samples representing small objects in the one or more image frames, thereby improving training of one or more AI models. The AI models can be trained, in at least some implementations, to detect such objects having various shapes and/or sizes.

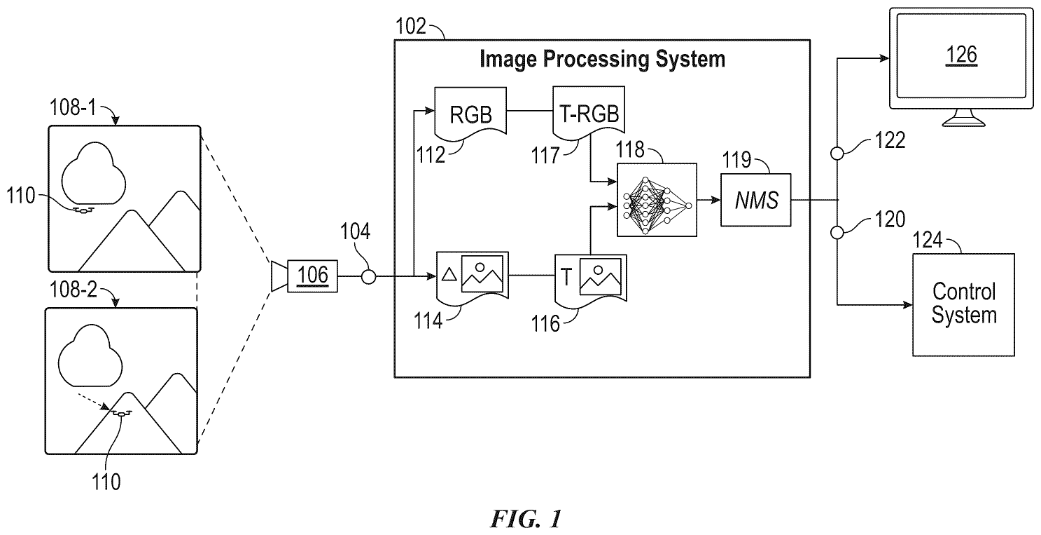

FIG. 1 shows an environment 100 in which an image processing system detects target objects in video data according to one or more instances. An image processing system 102 receives real-time video data 104 from an image capturing device 106. The image capturing system 106 can be a collection of one or more imaging devices (e.g., a video camera, a phone camera, internet protocol (IP) camera, surveillance camera) configured to generate image data 104 generated based on input to one or more imaging sensors (e.g., charge-coupled device sensors, complementary metal oxide semiconductor sensors). In some instances, the image capturing system 106 can include thermal detection or other systems for detection, such as an Electro-Optical (ER), Infra-Red (IF) system, radar, and/or GPS, to detect objects during non-optimal lighting conditions.

In some instances, more than one image capturing system 106 can be used to supplement each other, such as a high-resolution system supplementing the quality image of a thermal detection system with lower resolution or using radar to better understand motion, such as motion trajectory in 3-dimensional space. For example, the image capturing system 106 can be a multi-modality system that includes more than one device to capture additional data, such as the ability to track target objects not only in 2-dimensional space, but 3-dimension space. In some instances, the multi-modality image capturing system 106 can be calibrated so that each system properly captures the target object at the same time, for example calibrating a high-resolution system and a radar or multiple cameras to be sampled at a constant rate. A data storage system (not shown) may receive and store the plurality of images 108 from image capturing system 106. The data storage system may include volatile and/or non-volatile data storage (e.g., Read Only Memory (ROM), Random Access Memory (RAM), flash memory, solid state memory). The data storage system may reside internally in the image capturing system 106 or coupled to the image capturing system 106.

The video data 104 comprises a plurality of images 108, such as 108-1, 108-2, . . . 108-N (collectively “images”), in which a UAV 110 can be moving. In the video data 104, the UAV 110 can be represented by a small number of pixels relative to the overall number of pixels in the images 108.

The image processing system 102 can be configured to provide RGB data 112, or other color-based data, and differential image data 114. The differential image data 114 can be determined by comparing changes between two different image frames, e.g. images 108-1 and 108-2, across each pixel. In some instances, the differential image data 114 can be processed by comparing to a threshold value to generate threshold motion data 116. In some instances, the image processing system 102 may process the RGB data 112 by comparing to a threshold value to generate threshold RGB data 117. Alternatively, in environment 100, the image processing system 102 can be configured to generate RGB data 112 as differential RGB data by using differences between RGB data of successive or subsequent frames of the video data 104, for example, by processing each image frame more than once, e.g. a greyscale value of each image frame, and instead separating the image frame into a red image frame containing the red valued pixels, a green image frame containing the greed valued pixels, and a blue image frame containing the blue valued pixels. Each of these subset image frames is then compared to the corresponding subsequent image frame.

In various aspects, the system 100 implements artificial intelligence, such as a neural network (NN) model 118 to detect, identify, classify and/or track the object(s) in one or more image frames. In various implementations, the NN model 118 can be specifically trained for detection and tracking of objects represented by a small number of pixels in diverse image sets. The NN model 118 may be trained using image data to adapt the efficient and effective object detections and tracking techniques to the real-world scenarios. The NN model 118 can employ synthetic data (or simulated data) and/or real-world factual data (e.g., actual field data) that includes a mixture of image data that can be annotated for training. Additionally, the NN model 118 can be improved over time by collecting additional data to fine-tune it. The NN model 118 can be configured to be integrated into computer or processing systems equipped with memory and processing capabilities.

A trained NN model 118 receives the differential image data 114 (or threshold motion data 116) and the RGB data 112 (or the threshold RGB data 117 or differential RGB data) from the video data 104 and, using the differential image data 114 (or threshold motion data 116), identifies UAVs 110 moving in the video data 104. In some instances, the differential image data 114 would be added as a layer onto the RGB data 112, for example as a 4th layer to input RGBD data. In some instances, where differential RGB data is used, the layering could be RGBDRDGDB data as an input to the NN model 118. In some instances, multiple frames can be stacked, or subset tile of the frames, can be stacked to be inputted together. The NN model 118 can be trained to specifically detect the movement of UAVs represented by a small number of pixels in the video data 104. More specifically, the NN model 118 can be trained to detect UAVs 110 (or other target objects) using differential image data 114 (or threshold motion data 116) and the RGB data 112 (or the threshold RGB data 117). The NN model 118 can be trained using training data including differential image data 114 (or threshold motion data 116) and RGB data 112 (or the threshold RGB data 117) in which UAVs can be moving. The training data may also include differential image data 114 (or threshold motion data 116) in which other objects, such as birds or leaves, can be moving. The training data may include differential image data 114 (or threshold motion data 116) in which fast-moving objects, such as bullets, rocket-propelled devices, or other projectiles, can be moving. As a result, the NN model 118 can accurately distinguish between the motion of UAVs 110 and the movement of other types of objects.

The NN model 118, in some instances, generates location data 120 indicating locations of the UAVs 110 detected in motion in the video data 104. The location data 120 may include or be correlated with the angle of rotation (e.g., Azimuth) and/or angle of elevation of the image capturing device 106 to provide an accurate location of the moving UAV 110 relative to the image capturing device 106. In some instances, the NN model 118 can determine and/or predict the future location of the UAVs 110 detected, such as by analyzing the motion data. As mentioned, the location data 120 and predicted location can be in 2-dimensional and/or 3-dimensional space. The NN model 118, in some instances, generates a bounding box around each UAV 110 detected in motion in the video data 104. The bounding box can be a region highlighted as square shaped or rectangular shape or circular shape marking around the detected object. Generated bounding boxes, in some instances, may be colored, such as to differentiate relative confidence scores associated with detected objects, such as red, yellow, and green boxes. During training, the detected objects may be identified as ground truths. In various implementations, the bounding box can be presented with the tracking information. The NN model 118 can also include motion data for the tracked object, such as the predicted velocity, moving direction, and expected position.

The NN model 118 may also generate a confidence score indicating a level of confidence that the object detected is a target object, such as a UAV 110. The NN model 118 generates processed image data 122 that includes bounding boxes overlaid on locations of the moving UAVs 110 in the RGB data 112. However, in some instances, the precisions of the NN model 118 may be lower than wanted, as the NN model 118 may capture non-targeted objects (e.g., manned aerial vehicles, animals, weather phenomenon, image capturing errors, projectiles, etc.) as false positives. Thus, in some instances, the image processing system 102 can include an NMS 119 to suppress the least likely detected objects, such as the worse bounding boxes with the lowest confidence score. The NMS 119 can be based off a threshold that only outputs tracked objects that are above the threshold value. In some instances, the image processing system 102 can also include intelligent motion detecting software (or program), and various other training models to perform target object recognition, and various other feature data of the object in the real time image frames. In some instances, the image processing system 102 may include one or more processors or electronic processing systems.

The image processing system 102 outputs the processed image data 122 of the image processing of the image frame(s) to one or more devices and/or systems, such as a computing device and/or a control system. The computing device may be a desktop computer, a laptop or notebook or tablet computer or digital media player or any other suitable electronic device. The computing device, based on the output received from the image processing system 102, displays various information of the detected object and tracking information of the object in an image frame, for example, the display screen of the computing device can display detected object surrounded by the bounding box, name of the object, type of the target object, shape of the target object, color of the target object, a status indicating any payload attached to the target object, brand of the target object, speed of the target object, altitude of the target object, direction of the target object, or other technical data associated with the target object in the image frame(s). In some instances, an alert system (which may include one or more processors or electronic processing systems) may notify or alert a user if a detected object is determined to be carrying a payload. In such instances, the alert may be presenting the detected object on a user interface (such as, a display), changing an indicator color or value on the bounding box for the detected object, prompting a message on the user interface, prompting a noise or vibration to the user, and/or any combination thereof. In some instances, an alert system may present an alert or notification to the user if any targeted object of interest is detected, and may indicate which section (or tile) of the image frame the detected object is located in. Additionally, the user can be notified by a sound, vibration, alert, and/or combination thereof. In various implementations, the bounding box that includes the detected object also shows values of the object, such as confidence score, altitude, and directional details of the object, etc. In some implementations, the image processing system 102 can be configured to output video data including the images 108 with bounding boxes around the detected target objects. In some implementations, the image processing system 102 can be configured to output video data of the plurality of images 108 that includes a confidence score and the motion data associated with each bounding box and/or other technical data described herein.

The location data 120 may be provided to a control system 124 configured to control devices for neutralizing, destroying, or deactivating the UAVs 110 detected. The location data 120 provided to the control system 124 may include other information, such as the confidence score associated with each UAV 110 detected and those described above, such as motion data. In some instances, the control system 124 and alert system may include one or more processors or electronic processing systems.

In some instances, the network model can enable the construction of a mixed Gaussian Receptive Field (GRF) that can be adapted to different shapes of objects imaged to identify whether an object is an object of interest for targeting based on determining the movement of the target option in temporal space to determine temporal features, as well as spatial features. For example, a multi-modality system implementing both high-definition cameras and radar can account for the motion trajectory as an anchor point of a target object in comparison to other potential objects, e.g. how a UAV takes off versus a how a bird begins flight. GRF mixtures can be applicable to the identification of various object shapes, for example, UAVs or other flying objects of interest, at a distance. For small objects that cannot be identified even with multiple GRF due to the relatively small number of pixels representing the object results in low-quality images of the objects, additional motion data can help to compensate the amount of data points needed to analyze the target object. For example, without motion data, it may be difficult to even detect whether the object is a UAV, let alone identify it against a flying animal, such as a bird. However, by incorporating motion data, and in some instances 3D motion data, there can be additional data point to not only help detect the target object, but distinguish what the object is by including additional receptive fields that can focus on type of motion of a targeted object to better identify whether the target object (e.g., an unmanned vehicle, such as a UAV) is actually the target object rather than one of many potential objects (e.g., animals, such as birds, or manned vehicles, such as planes, etc.).

The foregoing features can facilitate the modeling of the geometric relationship between any detection and/or tracking point in relation to the actual moving target. Various aspects of the present disclosure include training of a You-Only-Look-Once (YOLO) architecture for generating GRFs in real-time for registering objects represented by a small number of pixels in image data. The use of a neural network, such as the YOLO architecture, can determine where a targeted object may be.

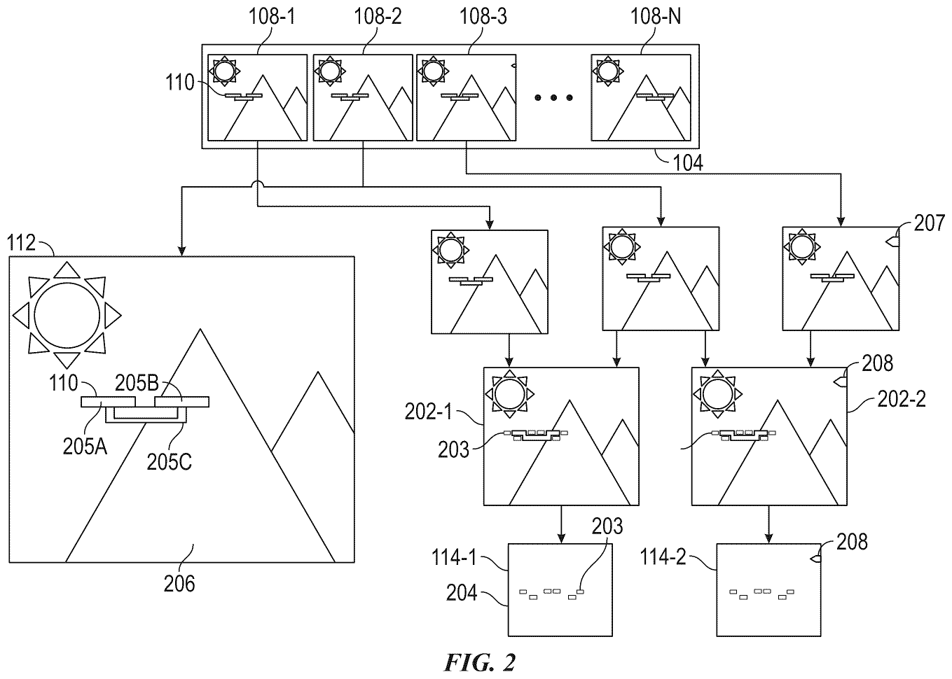

FIG. 2 shows how the image processing system 102 uses the plurality of images 108 as both video data 104 and differential image data 114. As mentioned, the image processing system 102 can be configured to provide RGB data 112 and differential image data 114. The RGB data 112 can include color data for each of the plurality of images 108, for example in image 108-2, the RGB data 112 for the image frame can include a depiction of the UAV 110 and a background 206, with the color values each producing a layer of data, e.g., red data 205A, green data 205B, and blue data 205C can be used to represent the UAV 110. It should be appreciated that each pixel in the image frame can have a distinct value for the red data 205A, green data 205B, and blue data 205C. The differential image data 114 includes data indicating differences between successive images in the video data 104, such as by open sequencing. In some instances, the differential image data 114 can be grey-scaled, such as to reduce the amount of data that may need to be processed without losing the information provided by the difference in the images. More particularly, the image processing system 102 generates the differential image data 114 by obtaining differences between background image data between successive images 108-1 and 108-2. For instance, the motion blurred image 201-1, 201-2 can display image changes 203 between different images. In some instances, these can also include false positive changes 208 caused by non-targeted objects 207 in the image frame. The image processing system 102 may implement a background subtraction method to generate the differential image data 114 in some instances. For instance, images 108-1 and 108-2 may be grey-scaled prior to comparison so that the difference in pixel values in each corresponding spot can be more easily compared. Because the background of the images should correspond quite similarly between successive image frames, the method should be able to capture the changes of pixels caused by the movement of the UAV. For successive pairs of images, the differential image data 114 can be represented by the following Equation 1:

$$D ( x , y ) = \vert {I}_{t} ( x , y ) - {I}_{t + 1} ( x , y ) \vert \qquad [ 1 ]$$

Iₜ can represent the current image, e.g., image 108-1, and Iₜ₊₁ can represent the subsequent image frame, e.g., image 108-2, and (x,y) represent the respective position in an image. For example, if an image frame has a resolution of 100×100 pixels, then it has 10,000pixel each corresponding to a particular position in the image from (1,1) to (100,100). Accordingly D(x,y) represents the subtracted value at the particular pixel location's values changing between the image frames. For example, if images 108-1 and 108-2 were 2×2 pixel images, and the pixel values corresponding to positions [(1,1), (1,2), (2,1), (2,2)] for image 108-1 was [1,0,3,5] and for image 108-2 was [2,0,6,5], then D (x,y) would be [1,03,0] after taking the absolute value, as shown by Equation 1, which would show a change at positions (1,1) and (2,1), where the respective D(x,y) values at 0, the background 204, may be represented as black and the D(x,y) with values, the image changes 203 and false positive changes 208, may be indicated with shade of grey progressively lighter as the value goes up. This is not intended be limiting, as zero values may be white and non-zero values being grey getting progressively darker, or some other indication.

In some instances, the differential image data 114 may correspond to a difference between one image and a subsequent image that may not be successive. Using non-subsequent images can be used to increase the speed of the system by reducing the number of frames for comparison and therefore the processing requirements. Similarly, comparing a single image frame to multiple different image frames, e.g. comparing image 108-1 with image 108-2 and separate with image 108-3, can provide a confirmation test to determine whether the system is operating correctly to verify the UAVs location. This multiple comparison can be completed in parallel so that the image processing system 102 could be able to process the comparison of both image 108-1 with image 108-2 and image 108-1 and image 108-2, simultaneously. In some instances, the image processing system 102 can simultaneously process subsequent images at the same time as well, such as processing both image 108-1 with image 108-2 and image 108-2 with image 108-3 at the same time. Additionally, non-subsequent sampling of image frames can be adjusted according to the expected speed of the target object, for example, for slower or less constantly moving objects, such as birds, the sampling rate for images may need to be decreased to better capture the motion data. For instance, the differential image data 114 may be a difference between image data at a first frame and image data at a third frame, a difference between image data at a first frame and image data at a fifth frame, or a difference between image data at a first frame and image data at a tenth frame, by way of non-limiting example. According, Equation 1 may be adjusted when using non-successive image frames. For example, taking every 5th image frame, the differential image data 114 can be represented by the following Equation 2:

$$D ( x , y ) = \vert {I}_{t} ( x , y ) - {I}_{t + 5} ( x , y ) \vert \qquad [ 2 ]$$

In some instances, the differential image data 114 can be determined using optical flow techniques. Similar to the subtraction method, optical flow techniques can generate differential image data 114 by propagating the features of key frames from the plurality of images 108 and interpolating to the non-key frames. Although the processing requirements for optical flow techniques can be more intensive than the back subtraction method and/or may include erratic motion of the target object, such as from changes in lighting conditions, it can be leveraged to smooth the features in each frame and aggregate them. The method can include using trackers to find a target object and push the information regarding down the network based on the determined confidence score of the detected target object.

In some instances, the differential image data 114 can be processed via a binary step function at value T₁ to generate threshold motion data 116. However, due to changes in lighting or other conditions, there may be some changes in the background of images 108-1 and 108-2, and therefore, the subtraction method can include a threshold value to compare the change in pixel value at each respective portion between images 108-1 and 108-2. The threshold motion data 116 can be differential image data having a value equal to or exceeding a threshold value T₁. The higher the threshold value T₁, the less noise there will be, but this may also result in filtering some UAVs. A lower threshold value, T1, generally results in more accurate detection of UAVs. However despite the more accurate detection by selecting a particular threshold value to reduce recall, too large of a threshold value may cause latency that could result in many noisy region that could make the processing the NN model 118 infeasible In some instances, the threshold value may be included so that any value below the threshold value is treated as zero. For example, if the threshold value were 2, then for the above example D(x,y) would be [0,0,3,0]. By further example, in some instances, 208//may be reduced to a 204//if the corresponding value is below the threshold value.

In some instances, the image processing system 102 may process the RGB data 112 via a binary step function at value T₂ to generate threshold RGB data 117. The threshold RGB data 117 can be color data having a value equal to or exceeding a threshold value T2, which can be a different threshold than the threshold T₁. The threshold RGB data 117 may filter out pixels having certain color characteristics that do not correspond to UAVs or other target objects of interest.

As mentioned above, alternatively, in environment 100, the image processing system 102 can be configured to generate RGB data 112 as differential RGB data by using differences between RGB data of successive or subsequent frames of the video data 104. For instance, the differential RGB data can include multiple sets of differential data, in comparison to greyscale differential data, such as by obtaining a difference between the red data of image 108-1 and the red data of image 108-2, obtaining a difference between the blue data of image 108-1 and the blue data of image 108-2, and obtaining a difference between the green data of image 108-1 and the green data of image 108-2. In some instances, the image processing system 102 may generate threshold RGB data 117 corresponding to the differential RGB data 112 having a value that exceeds a threshold TR, TG, and/or TB. In such instances, the NN model 118 can be trained to detect UAVs 110 or other target objects using the differential image data 114 (or threshold motion data 116) and the differential RGB data 112 (or the threshold RGB data 117).

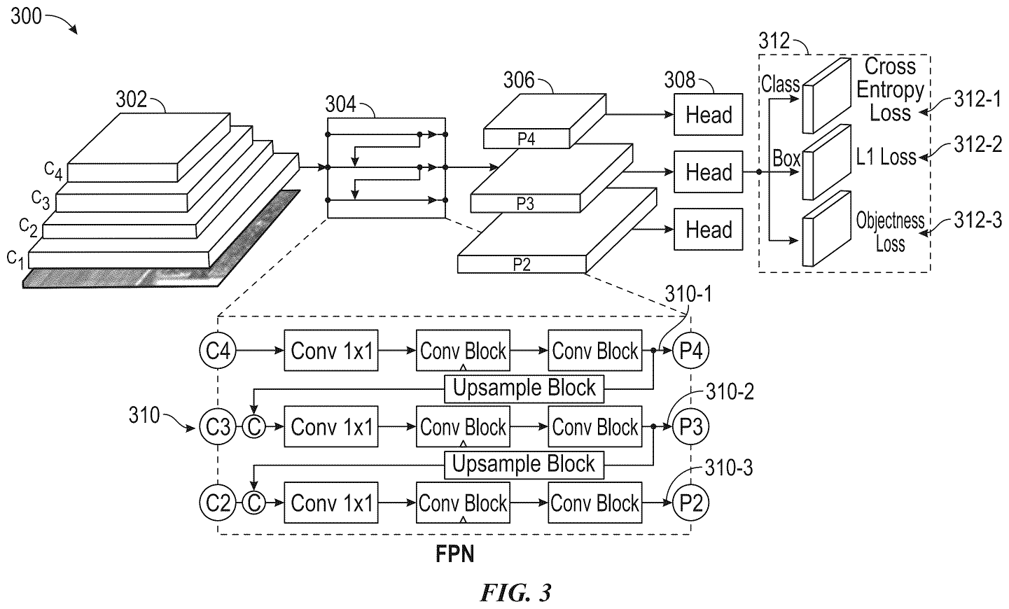

FIG. 3 shows a training process of a NN model of an image processing system according to one or more aspects. More particularly, FIG. 3 illustrates an architecture 300 than can take image data (e.g., differential image data 114, threshold motion data 116) as input at 302 and employs a deep neural network model or a convolutional neural network to detect motion of the target object in the image. In some instances, the NN model 118 undergoes supervised training to alleviate false positives by providing label assignments to ground truths. The architecture 300 described in FIG. 3 is a YOLO architecture classified mainly into: YOLO backbone (e.g., 302), YOLO neck (e.g., 304, 306, 310), YOLO head (e.g., 308) and YOLO loss 312. The YOLO backbone can be a convolutional neural network that pools image pixels to form features at different resolutions. The YOLO backbone can be pretrained on a classification dataset, such as ImageNet, in order to reduce the size of the input data while maintaining relevant features. The YOLO Neck can combine and mix the varying representations resolution output by the YOLO backbone. The YOLO Head can make the bounding box and class prediction based on the mixed representations. During YOLO loss, the predictions and classifications can be scrutinized using three loss functions, such as for class, box, and/or objectness.

The architecture 300 can takes image data as input at 302 and employs a DNN or CNN to detect one or more target objects (e.g., UAVs 110) in the image data. To begin the process, the input image frame can be divided into various grid cells (e.g., tiles) or equal shapes for example, into N×N grid cells, where N is a numeric value of any number of grid cells. The division of the image into grids can be for very large images to reduce the processing requirement for processing the whole image frame at once. For instance, the input image frame can be divided into tiles (or grid) of 2×2, 3×3, 4×4, . . . ,N×N. Each tile (or grid) can be then compressed or downsampled to create a dataset. The compressed dataset of each tile of each image frame is shown as C1, C2, C3, and C4 in 302. In various implementations, a combination of image frame and tile of the image frame are fed together as an input to the training model at 302. A network model, such as a neural network or Convolutional Neural Network (CNN), can be established that pools image pixels to form features at different resolutions. The network model can employ a pretrained model trained on synthetic data (or simulated data) and real-world factual data (e.g., actual field data) that includes a mixture of image data. Simulated data can include digitally created data, such as hyper realistic images created by graphics engines. The image data can include both targeted objects (e.g., unmanned vehicles, etc.) and non-targeted objects (e.g., animals or manned vehicles, etc.) in various scenarios. For example, image data can be a depiction of the objects in various scenarios, including but not limited to blurred images, image data from various lighting conditions, actual field data, images of various objects in numerous shapes and sizes, images of various objects in different orientations or distances, etc. Each of the images in the image data can be labeled with the particular type of object (e.g., rotor UAVs, wing UAVs, birds, airplanes, etc.) represented in the image, and in some instances, can include scenarios associated with the object in the image. The model can be trained with this image data, and corresponding labels, to be able to distinguish between different objects in a variety of different scenarios.

The backbone 302 can processes each tile and image frame sequentially, concurrently, or a combination of, in the convolutional layers of the CNN model. The CNN model extracts feature representations from different resolutions of the input image. The input tiles and image frames undergo a series of convolutions and pooling operations in the convolutional layer and filters to analyze image, by detecting edges, textures, and visual patterns of the object. The feature extraction capability allows the model to capture essential details and patterns from the image, making it ideal for object detection.

In various implementations, the input image frame can be divided into multiple tiles and object detection can be applied on each tile independently. In various implementations, the input image frame can be divided into multiple tiles and motion detection can be applied on each tile independently. Whereas, in various other implementations, motion detection can be applied to each tile of the image frame and the image frame itself. The motion detection training captures local details and variations in motion of target objects within each tile. Whereas, in various other implementations, object detection can be applied to each tile of the image frame and the image frame itself. The process captures local details and variations in the appearance of tiny objects within each tile. This can help to reduce the ratio of pixels from the tiny object versus the size of a smaller image tile as compared to the size of the larger image frame. As described herein, these tiny objects can be typically far away from the image-capturing device and therefore can be minuscule in comparison to the total image size (such as, but not limited to, being 1/50^{th}, 1/100^{th}, 1/150^{th}, 1/200^{th}, 1/300^{th}, 1/500^{th}, 1/750^{th}, 1/1000^{th}, etc., of the total image size) so that even after having been captured by a high definition camera, may be in the order of only 350 pixels, 250 pixels, 100 pixels, 90 pixels, 80 pixels, 65 pixels, 50 pixels, 35 pixels, 15 pixels, 5 pixels, 1 pixel, etc. These values are merely exemplary and are not intended to be limiting. By processing image tiles instead of the total image frame, the ratio is increased by a factor according to the number of tiles. For example, where an object is 1/120^{th} the size of a total image frame and the image frame is subdivided as a 4×3 grid into 12 tiles, the object compared to each tile will only be 1/10^{th} of the processed size of the image tile. Thus, the processing requirements to differentiate from the background can be reduced, as explained below.

In various implementations, the NN model 118 can be trained to detect the false and missed detections in each image frame. The false detection can be an area where there may be no object that can be present or there may not be enough foreground data of the object to be determined as an object. Whereas the missed detection can be where one or more objects can be present and were not detected by the model. The NN model 118 can be augmented, and the overall training process can be improved by updating the missed and false detection data to the neural network model.

A segmentation process can be thereafter incorporated into the object detection process to optimize the representation of objects in each tile. The segmentation process may involve dividing the image into meaningful regions based on visual similarities. The segmentation approach helps to appropriately process and identify the motion of target objects (e.g., UAVs 110) within each tile. The NN model 118 calculates the mean variance and weights of these receptive fields. In various implementations, the NN model 118 processes each pixel in each tile and uses learning algorithms or trained data to update the model. In various implementations, a background and foreground subtraction of pixels can be adopted by the NN model to determine the local changes of pixel data in each tile of the image frame(s) being processed. As such, by applying one or combination of above approaches the NN model 118 effectively models the appearance and motion of target objects, such as UAVs 110 within each tile.

Feature data can be created for each detected object in each tile of the image frame. More particularly, feature pyramid network (FPN) can be created in process 304 that extracts features of each dimension and upsamples the feature data using upsampling techniques in process 310. In various implementations, a feature pyramid network 306 can be created by taking the feature maps generated at different layers of CNN and aggregating them to form a pyramid of feature maps. The feature pyramid networks include multiple levels of resolution, and each level corresponds to different spatial resolutions.

In order to create the features of detected object in each tile of the image frame to form the feature pyramid 306, an upsampling technique can be implemented under 310. The upsampling technique can be helpful to detect the motion of tiny target objects more effectively. In 310, the data can be magnified for each detected object of each tile of the image frame. In FIG. 3, input 310 shows the upsampling process of image data whereas, output 310-1, 310-2, 310-3 shows the upsampling process of each detected object of each tile of each image frame. As such, the magnification of data in the upsampling step in 310 focuses on each tile containing the tiny object. The upsampling process enables the CNN model to capture intricate details and reduce the latency during object classification.

The upsampled image data of each detected object in each tile undergoes a series of convolutions and pooling operations in the convolutional layers to identify visual features and pattern of object from the tile. The top-down pathway technique shown as 310-1, 310-2, 310-3 can be responsible for upsampling the lower-level feature maps to match the size of higher-level feature maps. For example, the lower-resolution feature maps can be expanded to match the dimensions of the higher-resolution feature map so that the network captures finer details and features from lower layers while maintaining spatial information from higher layers.

After the upsampling process, the aggregated feature maps from process 304 forms feature pyramid 306. Feature pyramid 306 includes feature maps of objects at multiple scales and different spatial resolutions. The multi-scale feature representation enables the YOLO model to detect objects of various sizes and scales effectively.

The feature maps from feature pyramid 306 can be fed into head 308. The head 308 can be responsible for making the object predictions, including bounding boxes, class probabilities (or classifications). In various implementations, the feature maps from the feature pyramid 206 contains rich contextual information that helps YOLO head 208 to detect the motion of target objects and create bounding boxes around the detected target objects and track the object. In various implementations, the bounding box can be labeled with confidence scores (or ground truth values) and other tracking details. The bounding box can be a precise outline that shows the object and object's location in an image frame whereas, the confidence score to the bounding box indicates the model's certainty about the presence of an object (e.g., UAV) in a given region. In some instances, the confidence score can be affected by the quality and additional components of the image processing system 102 regarding image quality. Furthermore, the object tracking can specify the direction of object, altitude of object, speed of object.

In various implementation, the motion detection training involves monitoring the movement and location of detected objects across multiple consecutive image frames based on differences between greyscale image data. Based on the motion detection of a target object in successive image frames, the NN model continuously keeps processing the image frame for example two to three frame per second to track the detected object in each frame. In various implementations, the training model leverages its learned features and predictions from the previous image frames to track the detected objects over time. The continuous processing of image frames ensures consistent and real-time tracking, even when the objects appearance or position changes over the sequence of image frames. In various implementations, the target object motion detection provides the information such as direction of object, altitude of object, speed of object, predictions regarding flying path, etc.

In various implementations, during the object tracking process, the YOLO network updates the target object tracking predictions in each frame based on the new information available. For example, adding a new object or a new class label, etc. By refining the object's location and class label in each frame, the architecture 200 as a YOLO model provides a robust and accurate object tracking information. The model can be trained to dynamically adapt the variations in target object appearance, motion, scale, lighting conditions, environmental conditions, etc. making it well-suited for the real world where the object can be constantly moving, and the location can be changing over time.

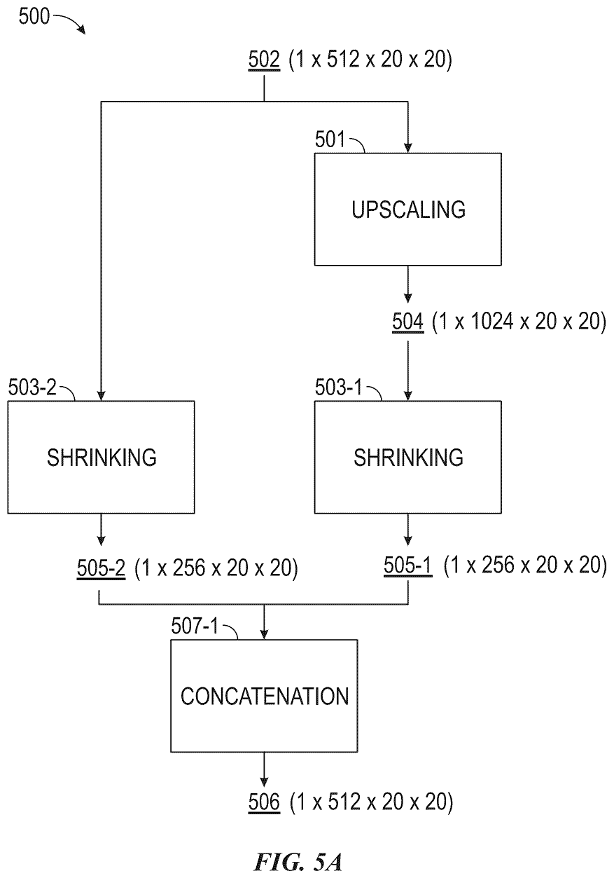

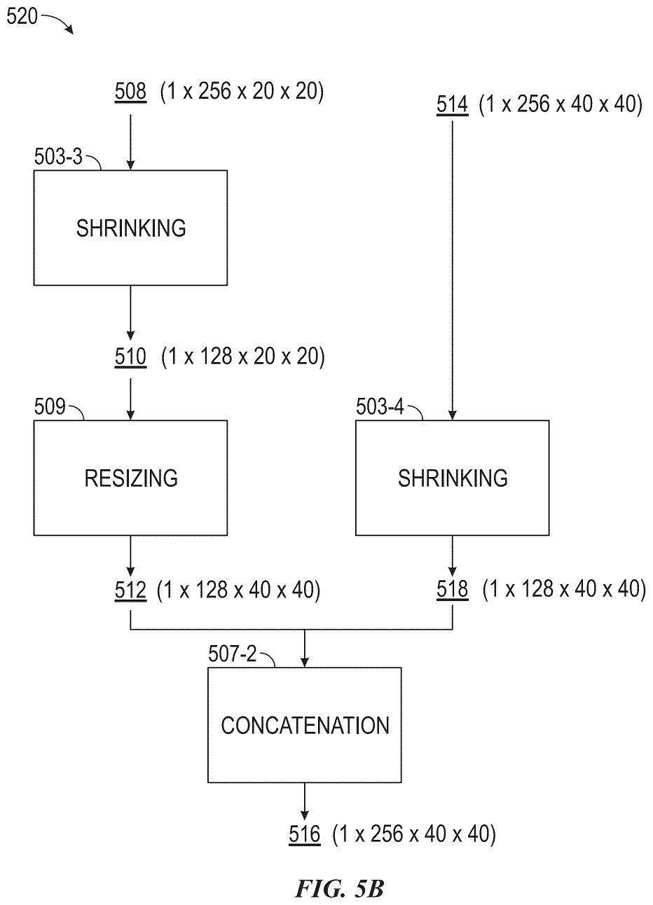

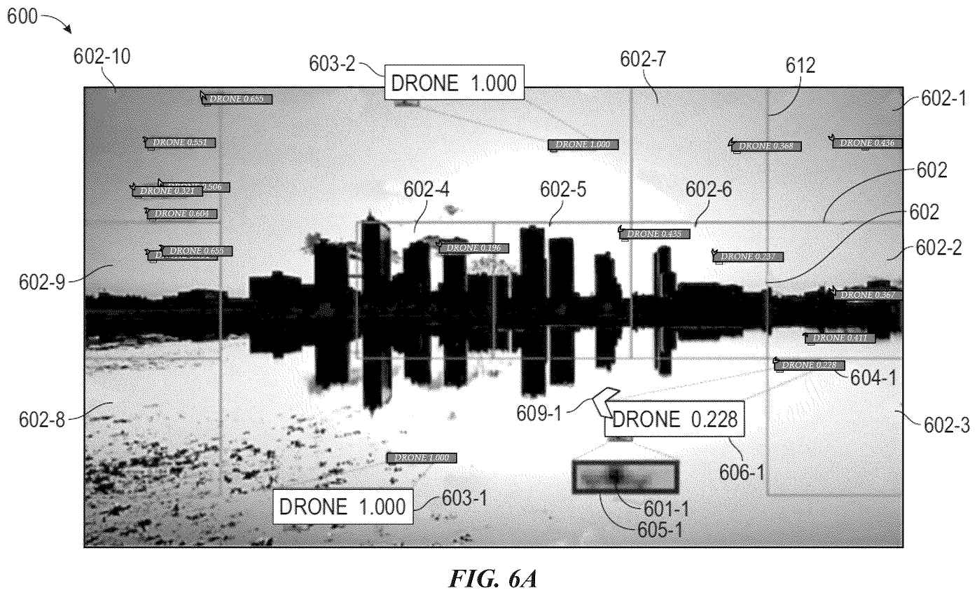

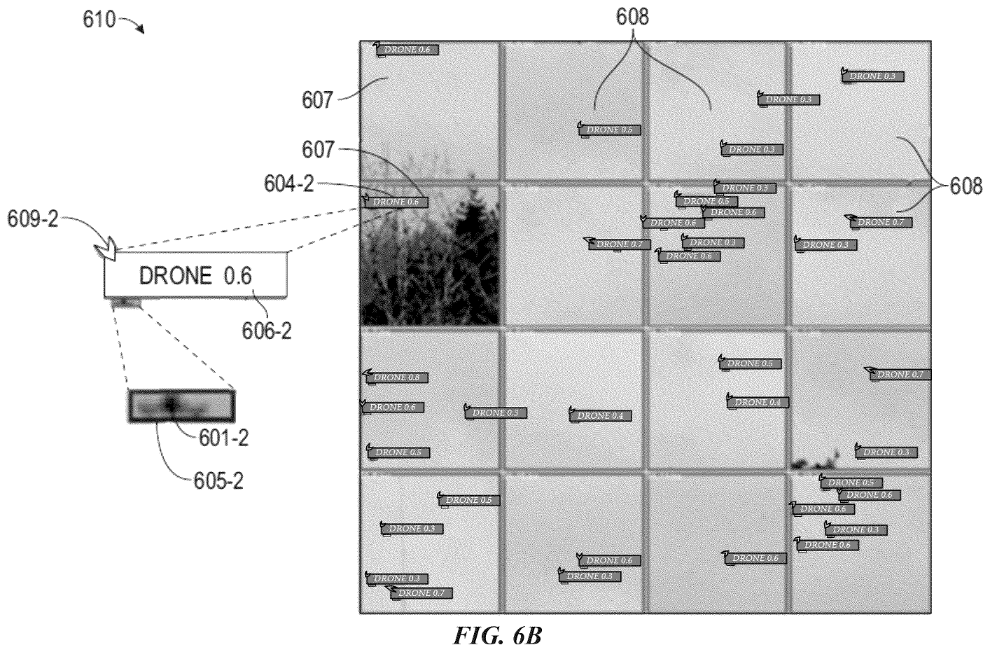

The loss 312 can be obtained as an output from the head 308 during the training process. The loss 312 can include three components, the class loss (312-1), the box loss (312-2), and the objectness loss (312-3), that can help to determine if there is an error in the NN model 118 to determine whether the determinations can be likely to be accurate. The class loss 312-1 measures the accuracy of class predictions for the detected object based on the maximum likelihood for each potential feature. The box loss 312-2 measures the accuracy of predicted bounding boxes coordinates compared to the ground truth boxes by comparing the amount of pixels in the image that are lost compared to the ground truth and background of the image. The objectness loss 312-3 evaluates the confidence of object predictions, indicating whether an object can be present in a given region. The loss 312 function combines these three components to calculate the overall loss 312 for the model during the training process. Additional details of training data and processing of each frame is further explained in FIGS. 5A-6B.

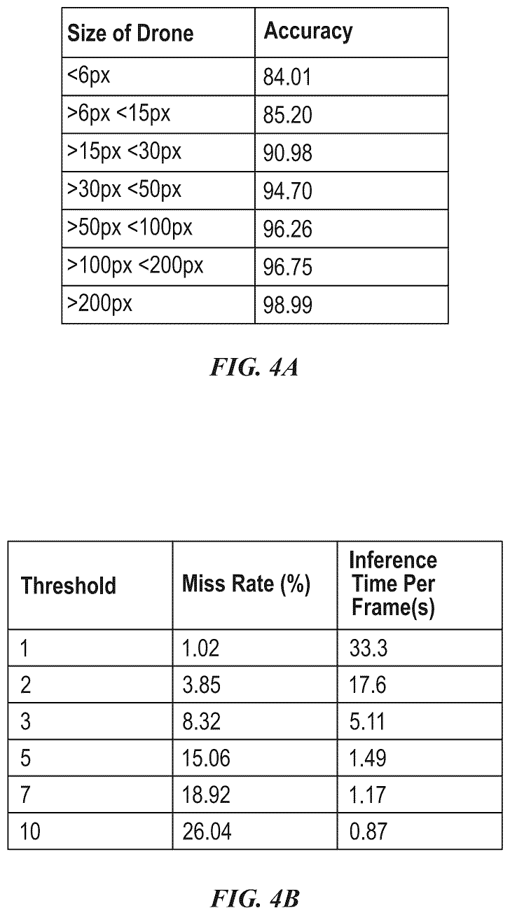

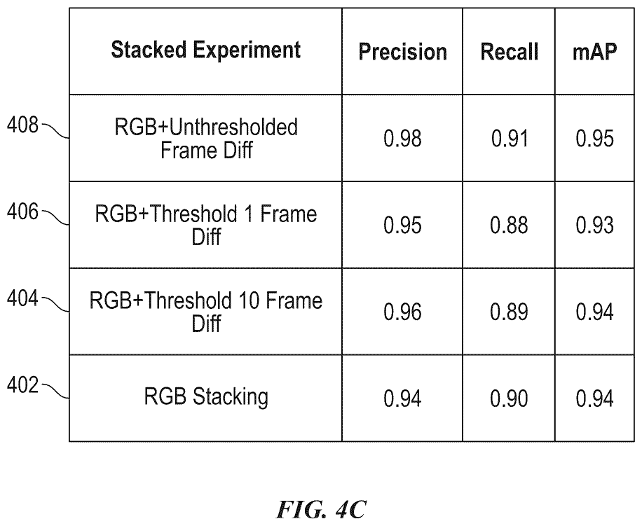

FIG. 4A shows an example set of results demonstrating the efficacy of the image processing system 102 implementing the NN model 118. In particular, the image processing system 102 has an accuracy of 84.01% in detecting UAVs comprising fewer than 6 pixels in 8 k×8 k video data. The image processing system 102 has an accuracy of 85.2% in detecting UAVs comprising between 6 and 14 pixels in 8 k×8 k video data. The image processing system 102 has an accuracy of 90.98% in detecting UAVs comprising between 15 and 29 pixels in 8 k×8 k video data. The image processing system 102 has an accuracy of 94.7% in detecting UAVs comprising between 30 and 50 pixels in 8 k×8 k video data. These values indicate a higher efficacy as compared to traditional approaches for detection of objects represented by a small number of pixels, particularly indicated by the almost 95% accuracy of detecting objects approximately 1/1280000^{th} of the image frame and only dropping to about 85% for objects 5 × smaller.

FIG. 4B shows an example set of results demonstrating efficacy metrics of the image processing system 102 implementing the NN model 118. More specifically, FIG. 4B demonstrates the variance in accuracy of the image processing system 102 to detect UAVs relative to the threshold T1 via the binary step function described with respect to FIG. 1. In particular, the image processing system 102 has a miss rate of 1.02% with a threshold value for T1 of 1. The image processing system 102 has a miss rate of 3.85% with a threshold value for T1 of 2. The image processing system 102 has a miss rate of 8.32% with a threshold value for T1 of 3. The image processing system 102 has a miss rate of 15.06% with a threshold value for T1 of 5. As can be seen, greater values for the threshold TI may result in a greater number of misses.

FIG. 4C shows a set of results demonstrating efficacy metrics of the image processing system 102 implementing the NN model 118. The metrics used include Precision, which is the true positives divided by the sum of true positives and false positives. The metrics also include Recall, which is the number of true positives divided by the sum of true positives and false negatives. In addition to the Precision-Recall metrics (which may be represented as a curve), the metrics further include mAP, which is mean Average Precision. As such, Recall is an indicator for false negatives, based on all targeted objects of interest that appeared in the data, and how many were correctly detected and classified. While Precision is an indicator for false positives, based on all targeted objects of interest that were detected in the data, how many were properly labeled as a targeted object when it should have been a non-targeted object.

The metrics of FIG. 4C include metrics 402 associated with data obtained when using an RGB stacking method in combination with greyscale stacking, such as for RGBD data, as described with respect to FIG. 3 The metrics 402 indicate that such an image processing system 102 has a precision of ˜94%. The metrics of FIG. 4C include metrics 404 associated with data obtained when using RGB data and thresholded differential image data with a threshold value for T1 of 10, as described with respect to FIG. 1. The metrics 404 indicate that such an image processing system 102 has a precision of ˜96%. The metrics of FIG. 4C include metrics 406 associated with data obtained when using RGB data and thresholded differential image data with a threshold value for T1 of 1, as described with respect to FIG. 1. The metrics 406 indicate that such an image processing system 102 has a precision of ˜95%. The metrics of FIG. 4C include metrics 408 associated with data obtained when using RGB data and differential image data without a threshold value, as described with respect to FIG. 1. The metrics 408 indicate that such an image processing system 102 has a precision of ˜98%. These values further indicate a higher efficacy as compared to traditional approaches for detection of objects represented by a small number of pixels.

FIGS. 5A and 5B illustrate processes associated with image processing techniques according to some implementations. FIG. 5A shows a compound scaling process 500, while FIG. 5B illustrates a spatial upsampling process 520, such as within the example architecture 300. The compound scaling up depth and spatial upsampling processes can play an important role in enhancing the object detection capabilities of the NN model 118.

Some implementations of the disclosure address various challenges facing traditional approaches for detecting the tiniest objects in an image frame due to the loss of fine-grained features during down-sampling. To overcome this, an identity map to preserve low-level features in the feature maps can be incorporated. This can enable the NN model 118 to capture subtle details and enhance the detection of tiny objects. Additionally, residual blocks can be employed to retain low-level features and improve overall detection performance.

The compound scaling up depth process, as depicted in FIG. 5A, enhances the ability of the NN model 118 to capture and represent complex patterns in the input data by modifying the depth or number of channels in the feature maps. This empowers the network to handle various levels of complexity in the input data, leading to accurate and efficient object detection and localization. Furthermore, the multi-scale representation obtained through this process can significantly contribute to the high-performance object detection capabilities of the proposed framework, such as the YOLO architecture.

The process can begin with input tensor 502, which is illustrated with size 1×512×20×20, where “1” denotes the batch size, “512” denotes the number of channels, and “20×20” represents the spatial dimensions of the feature map. The network then can scale up the depth of the feature maps by upscaling 501 to increasing the number of channels from 512 to 1024, resulting in a tensor of a size 1×1024×20×20 (shown as tensor 504). In some implementations, the upsampling technique can increase the spatial resolution of the smallest detection head by two times, for example from 20×20 to 40×40. In some implementations, the upsampling technique can increase the spatial resolution of the smallest detection head from two times to four times, for example, from 20×20 to 80×80. The upsampled head can then be concatenated with the previous layer, facilitating the fusion of high-level and low-level features for robust object detection.

After the upscaling 501 process, the feature maps can be shrunk 503-1 back to 1×256×20×20 (shown as tensor 505-1) through various operations like convolutional layers and pooling, reducing the computational load while preserving essential information in the feature maps so that information relevant to each other are closer together. After the shrinking step, the tensor with 1×256×20×20 channels can be concatenated with another tensor of the same size, for example, 1×256×20'20 channels (shown as 505-2). This concatenation step (507-1) combines the information from both tensors, creating a multi-scale representation of the input data with a size of 1×512×20×20 (shown as output tensor 506). This enhancement significantly improves the object detection performance of the architecture by capturing and representing complex patterns and features in input data effectively.

The spatial up-sampling process 520, depicted in FIG. 5B, illustrates how the network elevates the spatial resolution of the feature maps, capturing finer details and enabling better localization of objects in the image.

The process begins with input tensor 508, illustrated with a size of 1×256×20×20, where “1” denotes the batch size, and “256: denotes the number of channels, and 20×20” denotes the spatial dimensions of the feature map. The network can first shrink 503-3 to reduce the tensor size to 1×128×20×20 (shown as tensor 510), effectively halving the spatial resolution along both dimensions. Subsequently, the feature maps can undergo resizing 512 to double their spatial resolution along both dimensions, resulting in a tensor size of 1×128×40×40 (shown as tensor 512). This spatial up-sampling step can augment the resolution, enabling the network to focus on finer details, which can be helpful for detecting and tracking smaller objects.

The up-sampled tensor 512, sized at 1×128×40×40, can be then concatenated 507-2 with another tensor 518 of the same size, which contains information from previous layers. The concatenation 507-2 can form the output tensor 516, with a size of 1×256×40×40, which can allow the network to retain and leverage relevant details at a higher spatial resolution, thus facilitating more accurate object detection and tracking. Furthermore, the previous layer's output tensor 516 can be used an input tensor 514, with the size of 1×256×40×40, can be shrunk 503-4 to get tensor 518 so that the size matches that of tensor 512.

The sizes and values provided above are illustrative of an example and not intended to be limiting. As such, the sizing and changes in sizing specified can be adjusted as appropriate according to the specifications of the image capturing system 106 and/or the NN model 118.

FIGS. 6A and 6B illustrate an output of an image processing system 102 according to some implementations. In FIG. 6A, image 600 can be a high resolution image captured during training. In some instances, the image 600 can be captured by a high-definition image capturing system 106, such as an 8K camera, and can have a resolution of 8000×8000. This resolution is intended to merely be an example and can be any resolution, such as 3000×3000,4000×4000, etc. Additionally, the image 600 can be captured based on an aggregation of more than one image capturing system 106. As described above, a detected object 601, such as a UAV, sought to be detected by the system 102 could a small portion of the total pixels in the image 600 and can be dependent on the distance of the detected object 601 detected by the image processing system 102. The image 600 displays a grid of tiles 602 in a 3×6 arrangement, with objects detected in one or more of the tiles 602 (e.g., 602-1, 602-2, . . . 602-10). The image 600 can be divided into multiple tiles, and each tile may undergo separate processing in the image processing system 102. In some instances, each grid containing multiple tiles can be processed sequentially and, in some instances, each grid can be concurrently processed.

By reducing the image 600 into one or more grids, the ratio of the detected object 601 to the amount of background is divided among the number of tiles, e.g., if the image 600 was 1800×1800, each tile would be 100×100 in FIG. 6A. After each tile is analyzed, it can be recombined to form the full image 600. As shown in FIG. 6A, grid lines 612 may only be displayed for grids 602 that include a detected object 601 to improve clarity for a human user, aside from ground truths 603. In contrast, FIG. 6B displays grid line for all grids 602, and in some instances, as shown, but include images for only particular grids 607 but not for other grids 608. In such instances, a particular detected object 601-2 may be of interest and the grids displayed may be those related to the position or expected position of the detected object 601-2.

The input image can be subjected to the above-described techniques by processing both RGB data and differential image data, or other variations described above, and inputted in a modified YOLO architecture within the NN model 118. The NN model 118 may provide object detection results for each grid or tile in every image frame, presenting bounding boxes (e.g., 604-1) around the detected objects (e.g., 601-1) and displaying a confidence score 606-1 for each detected object. For illustrative purposes, a magnified view has been included for detected object, which can include the detected object 601-1, a bounding box for the detected object 601-1, motion information 609-1, and the confidence score 606-1 alongside an “object” tag to help indicate the location of the 601-1, which is much smaller as shown. In some instances, the motion information 609-1 can include velocity, expected location, expected direction, etc. The motion information 609-1 can be illustrated as shown to point towards the direction of movement, cither in 2-D space or 3-D space, and can indicate speed based on the size of the indicator. In some implementations, the motion information 609-1 can be provided by including but not limited to text or number, using colors, or any combination thereof. In some instances, as shown, the confidence score 606 can be from 0.000 to 1.000, with a higher number indicating a higher likelihood of a detected object corresponding to a target object (e.g., a UAV). In some instances, the image 600 may not include objects that have a confidence score 606 below a threshold value, for example below 0.050. In some instances, the bounding boxes 604 can be depicted in a color, such as red, to help identify the associated detected object 601. Additionally, the image 600 can include ground truths 603 that have been annotated by the user, to help provide training comparisons and/or from user annotation due to a missed object. As shown, ground truths 603 has a confidence score of 1.000 to indicate that the object is at that position. Ground truths 603 may been depicted similarly to a detected object 601 but may be displayed in a different format to easily differentiate, such as a blue bounding box 604.

As mentioned above, FIG. 6A is illustrative of an output of image detecting system during the training process, as indicated by the representations of ground truth 603. Therefore, the confidence score and/or identifier 606 can be representative of loss functions calculated during the training process, such as those compared to the ground truths 603. FIG. 6B is an illustrative example of an output of image 610 detecting system during real-time use without ground truths. In such instances, the confidence scores 606 may not be related to loss functions, which are not calculated during non-training, but can be indicative of other factors mentioned above, such as image quality and comparisons to the training data. Additionally, the output of image processing system 102 during real-time use can appear more similarly to image 600 depicted in FIG. 6A without the ground truths 603 and where the confidence scores are as described for FIG. 6B, and can thus, illustrate the entirety of the image 600 and relevant grids (or portions thereof) during real-time use. In some instances, the output of image processing system 102 can be a video with the classification and tracking grids 602 and detected objects 601 overlayed on each associated frames of the video.

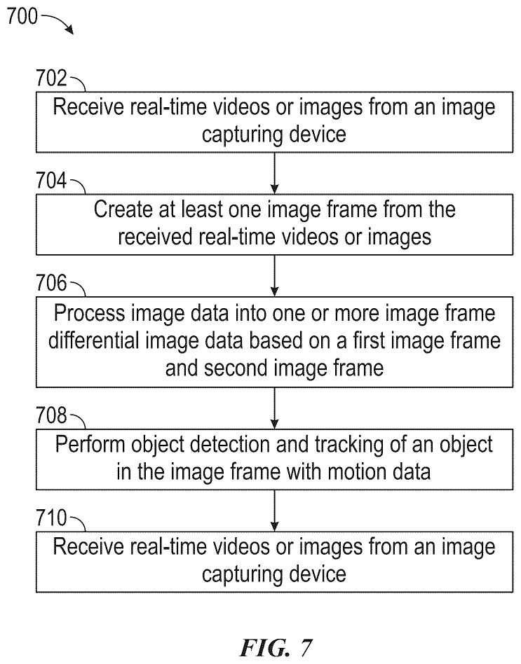

FIG. 7 illustrates a method 700 for performing target object detection and tracking according to one or more aspects. The method 700 can be implemented by the image processing system 102. The method 700 includes receiving real-time videos or images from an image capturing device 106, as shown in 702. The method 700 may further include obtaining image frames from the received real-time videos and images, as shown in 704. The method 700 further includes processing image data into differential data using a first image frame and a second image frame subsequent to the first frame, as shown in 706. In some instances after 706, the first image frame and the second image frame can each further be subdivided into a first set of image tiles and a second set of image tiles, with each image tile in a set corresponding to an image tile in another set. For example, if the first and second image frame were each divided into 100 image tiles each, the 1st image tile of the first image frame would correspond to the 1st image tile of the second image frame, the 52nd image tile of the first image frame would correspond to the 52nd image tile of the second image frame, etc. In some instances, this subdivision into image tiles can be after 704. The method 700 further includes inputting the differential data and the RGB data into an image analysis system, as shown in 708. In various aspects, the image analysis system (or sometimes referred to as an image analytic system) includes the image processing system 102 and object detection and tracking system that incorporates a YOLO architecture to detect an object and track an object in an image frame. The image analytic system may include one or more processors or electronic processing systems. In various implementation, the image analytic system includes a Convolutional training mode which can be trained on a diverse dataset comprising 4000 or more images having high resolution of about 3K×3K, and more than 120,000 positive training samples representing wide range of objects and scenarios, such as but not limited to different types of target objects (e.g., fixed-wing UAVs, multi-rotor UAVs, UAVs carrying payloads), target objects at different distances, target objects in different positions, target objects in different lighting, etc. The training samples may include various objects other than target objects, such as birds, projectiles, airplanes, etc. The method 700 further includes performing object detection and tracking of an object with motion data in each image frame by the image analytic system, as shown in 710.

### Other Variations

Any of the implementations disclosed herein can utilize any one or more features disclosed in U.S. patent application Ser. No. 18/794,926, filed on Aug. 5, 2024, which is incorporated by reference in its entirety. For example, U.S. patent application Ser. No. 18/794,926 includes description on the determination and use of Gaussian Receptive Fields (GRFs) for object identification. In some instances, such GRFs can be used to identify spatial and temporal features to identify both location data and motion data.

Features, materials, characteristics, or groups described in conjunction with a particular aspect, embodiment, or example are to be understood to be applicable to any other aspect, embodiment or example described herein unless incompatible therewith. All the features disclosed in this specification (including any accompanying claims, abstract and drawings), and/or all the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

While certain embodiments have been described, these embodiments have been presented by way of example only and are not intended to limit the scope of protection. Indeed, the novel methods and systems described herein may be embodied in a variety of other forms. Furthermore, various omissions, substitutions, and changes in the form of the methods and systems described herein may be made. Those skilled in the art will appreciate that in some embodiments, the actual steps taken in the processes disclosed and/or illustrated may differ from those shown in the figures. Depending on the embodiment, certain of the steps described above may be removed, others may be added. For example, the actual steps and/or order of steps taken in the disclosed processes may differ from those described and/or shown in the figure. Depending on the embodiment, certain of the steps described above may be removed, others may be added. For instance, the various components illustrated in the figures and/or described may be implemented as software and/or firmware on a processor, controller, ASIC, FPGA, and/or dedicated hardware. Furthermore, the features and attributes of the specific embodiments disclosed above may be combined in different ways to form additional embodiments, all of which fall within the scope of the present disclosure.

In some cases, there is provided a non-transitory computer readable medium storing instructions, which when executed by at least one computing or processing device, cause performing any of the methods as generally shown or described herein and equivalents thereof.

Any of the memory components described herein can include volatile memory, such random-access memory (RAM), dynamic random-access memory (DRAM), synchronous dynamic random-access memory (SDRAM), double data rate (DDR) memory, static random-access memory (SRAM), other volatile memory, or any combination thereof. Any of the memory components described herein can include non-volatile memory, such as magnetic storage, flash integrated circuits, read only memory (ROM), Chalcogenide random access memory (C-RAM), Phase Change Memory (PC-RAM or PRAM), Programmable Metallization Cell RAM (PMC-RAM or PMCm), Ovonic Unified Memory (OUM), Resistance RAM (RRAM), NAND memory (e.g., single-level cell (SLC) memory, multi-level cell (MLC) memory, or any combination thereof), NOR memory, EEPROM, Ferroelectric Memory (FeRAM), Magnetoresistive RAM (MRAM), other discrete NVM (non-volatile memory) chips, or any combination thereof.

Any user interface screens illustrated and described herein can include additional and/or alternative components. These components can include menus, lists, buttons, text boxes, labels, radio buttons, scroll bars, sliders, checkboxes, combo boxes, status bars, dialog boxes, windows, and the like. User interface screens can include additional and/or alternative information. Components can be arranged, grouped, displayed in any suitable order.

The term “set,” as used herein (e.g., a set of keys), refers to a non-empty collection of members. The phrase “coupled to,” as used herein and unless otherwise indicated by the context of the usage, means that a first circuit element is coupled to a second circuit element, with or without intervening elements therebetween.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without other input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, or within less than 0.01% of the stated amount.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations.

The foregoing description, for purposes of explanation, used specific nomenclature to provide a thorough understanding of the disclosure. However, it will be apparent to one skilled in the art that specific details are not required in order to practice the disclosed embodiments. Thus, the foregoing descriptions of specific embodiments are presented for purposes of illustration and description. They are not intended to be exhaustive or to limit the disclosure to the precise forms disclosed; obviously, many modifications and variations are possible in view of the above teachings. The embodiments were chosen and described in order to best explain the principles of the disclosure and its practical applications, they thereby enable others skilled in the art to best utilize the disclosure and various embodiments with various modifications as are suited to the particular use contemplated. It is intended that the claims as presented herein or as presented in the future and their equivalents define the scope of the protection.

1. An object detection system, comprising:
an image capture system configured to obtain image data comprising at least a first image frame and a second image frame; and
a memory storing instructions that, when executed by one or more processors, cause the one or more processors to:
process a first set of image data based on the first image frame,
process a second set of image data based on the first image frame and the second image frame, and
execute a network model configured to detect one or more targeted objects from a plurality of potential objects in the first image frame based on an input comprising the first set of image data and the second set of image data, the one or more targeted objects comprising less than 1/100th pixels of a total number of pixels in the first image frame.

2. The object detection system of claim 1, wherein the first set of image data comprises color data and the second set of image data comprises motion data.

3. The object detection system of claim 2, wherein execution of the instructions causes the one or more processors to determine the motion data based on a difference between the first image frame and the second image frame.

4. The object detection system of claim 3, wherein the motion data is determined according to: D(x, y)=|Iₜ(x, y)−I_{t +1}(x, y)|, wherein Iₜ(x, y) comprises a value at each pixel in the first image frame and Iₜ+1(x, y) comprises a value for each pixel in the second image frame.

5. The object detection system of claim 3, wherein at least one of the motion data is determined based on a comparison of the difference between the first image frame and the second image frame with a differential threshold value, or the color data comprises at least one threshold value determined based on a comparison of at least one value for each pixel of the first image frame and a threshold value.

6. The object detection system of claim 1, wherein the network model is configured to generate at least one Gaussian Receptive Fields (GRFs) to dynamically adapt to features of the one or more targeted objects in at least one of the first image frame or the second image frame.

7. The object detection system of claim 1, wherein execution of the instructions causes the one or more processors to:
divide the first image frame into a plurality of image tiles; and
detect the one or more targeted objects in each of the plurality of image tiles, the one or more targeted objects comprising less than a factor of each of the image tiles, the factor being 1/100th multiplied by a number of image tiles of the plurality of tiles, and wherein execution of the instructions cause the one or more processors to aggregate the plurality of images tiles for the detection of the one or more targeted objects in the first image frame.

8. The object detection system of claim 1, wherein the network model comprises a modified You Only Look Once (YOLO) architecture.

9. The object detection system of claim 1, wherein execution of the instructions causes the one or more processors to determine a confidence score for the one or more targeted objects and further comprising a display configured to display the first image frame, the one or more targeted objects, and features corresponding to each of the one or more targeted objects,
wherein execution of the instructions causes the one or more processors to determine the features comprising a bounding box surrounding the one or more targeted objects and the confidence score for the one or more targeted objects.

10. The object detection system of claim 9, wherein the features further comprise at least one of an expected velocity of the one or more targeted objects, a predicted position of the one or more targeted objects, or a direction of travel of the one or more targeted objects.

11. The object detection system of claim 9, wherein the one or more processors are further caused to detect the one or more targeted objects and the corresponding features in 500 milliseconds or less.

12. The object detection system of claim 1, wherein execution of the instructions causes the one or more processors to track the one or more targeted objects from the first image frame to the second image frame.

13. The object detection system of claim 1, wherein the plurality of potential objects comprises animals, unmanned vehicles, and manned vehicles, and wherein the one or more targeted objects comprise the unmanned vehicles.

14. The object detection system of claim 1, wherein the image capture system comprises at least one of:
a multi-modality image capture system,
one or more cameras configured for thermal detection,
one or more radars, or
one or more cameras configured to be synchronized together to capture images at a constant rate.

15. The object detection system of claim 1, wherein the network model is configured to determine at least one loss function associated with the detection of the one or more targeted objects.

16. The object detection system of claim 15, wherein execution of the instructions causes the one or more processors to determine a confidence score for the detection of the one or more targeted objects, the confidence score being associated with at least one of the at least one loss function or an image quality associated with the image data.

17. The object detection system of claim 1, wherein execution of the instructions causes the one or more processors to train the network model based on training data comprising the plurality of potential objects in various scenarios.

18. The object detection system of claim 1, wherein execution of the instructions causes the one or more processors to:
detect that the one or more targeted objects is carrying a payload, and
alert a user on a location of the one or more targeted objects carrying the payload.

19. The object detection system of claim 18, further comprising:
a neutralization system configured to neutralize the one or more targeted objects carrying the payload.

20. A method for detecting an object in an image frame, the method comprising, by one or more processors:
receiving real-time image data comprising a first image frame and a second image frame;
processing a first set of image data based on the first image frame;
processing a second set of image data based on the first image frame and the second image frame;
inputting the first set of image data and the second set of image data into a network model; and
with the network model, detecting one or more targeted objects from a plurality of potential objects in the first image frame, the one or more targeted objects comprising less than 1/100th pixels of a total number of pixels in the first image frame.

21. The method of claim 20, wherein the real-time image data is received at a first time, and the one or more targeted objects in the first image frame are detected at a second time, the second time being 500 milliseconds or less after the first time.

22. A method for training an object detection system, the method comprising, by one or more processors:
inputting training data comprising a plurality of potential objects in various scenarios into a network model, the plurality of potential objects comprising one or more targeted objects;
training the network model based on the training data to detect the one or more targeted objects from among the plurality of potential objects;
processing a first set of image data based on a first image frame and a second set of image data based on the first image frame and a second image frame;
inputting the first set of image data and the second set of image data into the network model, the network model configured to detect the one or more targeted objects in the first image frame, the one or more potential objects comprising less than 1/100^{th} pixels of a total number of pixels in the image frame;
processing at least a portion of the first image frame including at least one of the one or more targeted objects with the network model to detect the one or more targeted objects;
inputting, via a user interface. a ground truth for any of the one or more targeted objects not detected by the network model;
determining at least one loss function associated with each of the one or more targeted objects detected; and
re-training the network model based on the at least one loss function.
